(19) United States
(12) Patent Application Publication
(10) Pub. No.: US 2022/0121237 A1
(43) Pub. Date: Apr. 21, 2022

(54) FIT ADJUSTMENT OF A HEAD MOUNTED DISPLAY

(71) Applicant: LENOVO (Singapore) PTE. LTD., New Tech Park (SG)

(72) Inventors: Russell Speight VanBlon, Raleigh, NC (US); Thorsten P. Stremlau, Morrisville, NC (US); Kevin Wayne Beck, Raleigh, NC (US)

(21) Appl. No.: 17/071,448

(22) Filed: Oct. 15, 2020

(51) Int. Cl. G06F 1/16; G06V 40/10; G06T 7/60

(52) U.S. Cl. CPC G06F 1/163; G06T 2207/30196; G06T 7/60; G06V 40/10

(57) ABSTRACT

Apparatuses, methods, systems, and program products are disclosed for fit adjustment of a head mounted display. An apparatus includes a processor and a memory that stores code executable by the processor. The code is executable by the processor to identify a user based on information captured using one or more sensors of a head mounted display (“HMD”) unit. The code is executable by the processor to determine one or more fit settings for the identified user, the one or more fit settings for sizing the HMD unit to the identified user. The code is executable by the processor to automatically adjust the HMD unit based on the determined one or more fit settings for the identified user.

### FIELD

The subject matter disclosed herein relates to headsets and more particularly relates to fit adjustment of a head mounted display.

### BACKGROUND

Headsets such as head mounted displays may include straps, bands, or other mechanisms for securing the head mounted display to the user's head. Typically, these securing mechanisms are manually adjustable so that users can fit the head mounted display to their head sizes. However, manually resizing the securing mechanisms can be tedious or frustrating when the same head mounted display is worn by various different users, when user's change hairstyles, or the like.

### BRIEF SUMMARY

Apparatuses, methods, systems, and program products are disclosed for fit adjustment of a head mounted display. An apparatus, in one embodiment, includes a processor and a memory that stores code executable by the processor. The code is executable by the processor, in certain embodiments, to identify a user based on information captured using one or more sensors of a head mounted display (“HMD”) unit. The code, in further embodiments, is executable by the processor to determine one or more fit settings for the identified user, the one or more fit settings for sizing the HMD unit to the identified user. The code, in certain embodiments, is executable by the processor to automatically adjust the HMD unit based on the determined one or more fit settings for the identified user.

A method for fit adjustment of a head mounted display, in one embodiment, includes identifying, by a processor, a user based on information captured using one or more sensors of a head mounted display (“HMD”) unit. The method, in further embodiments, includes determining one or more fit settings for the identified user, the one or more fit settings for sizing the HMD unit to the identified user. In certain embodiments, the method includes automatically adjusting the HMD unit based on the determined one or more fit settings for the identified user.

A computer program product for fit adjustment of a head mounted display, in one embodiment, includes a computer readable storage medium having program instructions embodied therewith. In certain embodiments, the program instructions are executable by a processor to cause the processor to identify a user based on information captured using one or more sensors of a head mounted display (“HMD”) unit. In some embodiments, the program instructions are executable by a processor to cause the processor to determine one or more fit settings for the identified user, the one or more fit settings for sizing the HMD unit to the identified user. In further embodiments, the program instructions are executable by a processor to cause the processor to automatically adjust the HMD unit based on the determined one or more fit settings for the identified user.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a system for fit adjustment of a head mounted display;

FIG. 1B is depicts one embodiment of a head mounted display;

FIG. 2 is a schematic block diagram illustrating one embodiment of an apparatus for fit adjustment of a head mounted display;

FIG. 3 is a schematic block diagram illustrating one embodiment of another apparatus for fit adjustment of a head mounted display;

FIG. 4 is a schematic flow chart diagram illustrating one embodiment of a method for fit adjustment of a head mounted display; and

FIG. 5 is a schematic flow chart diagram illustrating one embodiment of another method for fit adjustment of a head mounted display.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. The code is executable by the processor, in certain embodiments, to identify a user based on information captured using one or more sensors of a head mounted display (“HMD”) unit. The code, in further embodiments, is executable by the processor to determine one or more fit settings for the identified user, the one or more fit settings for sizing the HMD unit to the identified user. The code, in certain embodiments, is executable by the processor to automatically adjust the HMD unit based on the determined one or more fit settings for the identified user.

In one embodiment, the code is executable by the processor to automatically adjust the HMD unit by adjusting at least one securing member that is configured to secure the HMD unit to the user's head. In further embodiments, the code is executable by the processor to actuate at least one motor of the HMD unit that is operably coupled to the at least one securing member to adjust the at least one securing member.

In one embodiment, the code is executable by the processor to automatically adjust the HMD unit by adjusting one or more characteristics of at least a portion of the HMD unit that is in contact with the user's head and is used to secure the HMD unit to the user's head, the at least a portion of the HMD unit comprising a shape memory alloy and/or a variable density foam that has an adjustable firmness.

In certain embodiments, the firmness of the shape memory alloy and/or the variable density foam is adjustable based on information sensed using one or more strain gauges integrated into the HMD unit.

In various embodiments, the code is executable by the processor to calibrate a fit of the HMD unit for the user to initially determine the one or more fit settings for the user. In some embodiments, the code is executable by the processor to instruct the user to point at least one camera of the HMD unit at the user's head, capture one or more images of the user's head using the camera, and determine one or more fit settings for the user based on the captured images.

In one embodiment, the code is executable by the processor to calculate a confidence with which the one or more fit settings are determined for the user, determine whether the confidence satisfies a predetermined threshold, and provide an indication to the user that the HMD unit is calibrated for the user responsive to the confidence satisfying the predetermined threshold.

In one embodiment, the code is executable by the processor to determine that a fit of the HMD unit is improper for the user, trigger recalibration of the fit of the HMD unit for the user, and update the one or more fit settings for the user based on the recalibration.

In some embodiments, the code is executable by the processor to identify the user based on at least one of image data captured using at least one camera of the HMD unit, biometric data captured using at least one biometric sensor of the HMD unit, and wireless signature data for a wireless device associated with the user using one or more wireless signal sensors of the HMD unit.

In one embodiment, the code is executable by the processor to further adjust the HMD unit based on one or more fit settings for an application executing on the HMD unit. In certain embodiments, the code is executable by the processor to further adjust the HMD unit based on input received from the user, the input comprising at least one of a voice command, a menu selection, and a gesture. In some embodiments, the code is executable by the processor to create different sets of fit settings for the user based on different fit modes that the user defines, the HMD unit adjusted according to the fit settings for a selected fit mode.

A method for fit adjustment of a head mounted display, in one embodiment, includes identifying, by a processor, a user based on information captured using one or more sensors of a head mounted display (“HMD”) unit. The method, in further embodiments, includes determining one or more fit settings for the identified user, the one or more fit settings for sizing the HMD unit to the identified user. In certain embodiments, the method includes automatically adjusting the HMD unit based on the determined one or more fit settings for the identified user.

In one embodiment, the method includes automatically adjusting the HMD unit by adjusting at least one securing member that is configured to secure the HMD unit to the user's head. In some embodiments, the method includes actuating at least one motor of the HMD unit that is operably coupled to the at least one securing member to adjust the at least one securing member.

In one embodiment, the method includes calibrating a fit of the HMD unit for the user to initially determine the one or more fit settings for the user by instructing the user to point at least one camera of the HMD unit at the user's head, capturing one or more images of the user's head using the camera, and determining one or more fit settings for the user based on the captured images.

In one embodiment, the method includes calculating a confidence with which the one or more fit settings are determined for the user, determining whether the confidence satisfies a predetermined threshold, and providing an indication to the user that the HMD unit is calibrated for the user responsive to the confidence satisfying the predetermined threshold.

In certain embodiments, the method includes determining that a fit of the HMD unit is improper for the user, triggering recalibration of the fit of the HMD unit for the user, and updating the one or more fit settings for the user based on the recalibration.

A computer program product for fit adjustment of a head mounted display, in one embodiment, includes a computer readable storage medium having program instructions embodied therewith. In certain embodiments, the program instructions are executable by a processor to cause the processor to identify a user based on information captured using one or more sensors of a head mounted display (“HMD”) unit. In some embodiments, the program instructions are executable by a processor to cause the processor to determine one or more fit settings for the identified user, the one or more fit settings for sizing the HMD unit to the identified user. In further embodiments, the program instructions are executable by a processor to cause the processor to automatically adjust the HMD unit based on the determined one or more fit settings for the identified user.

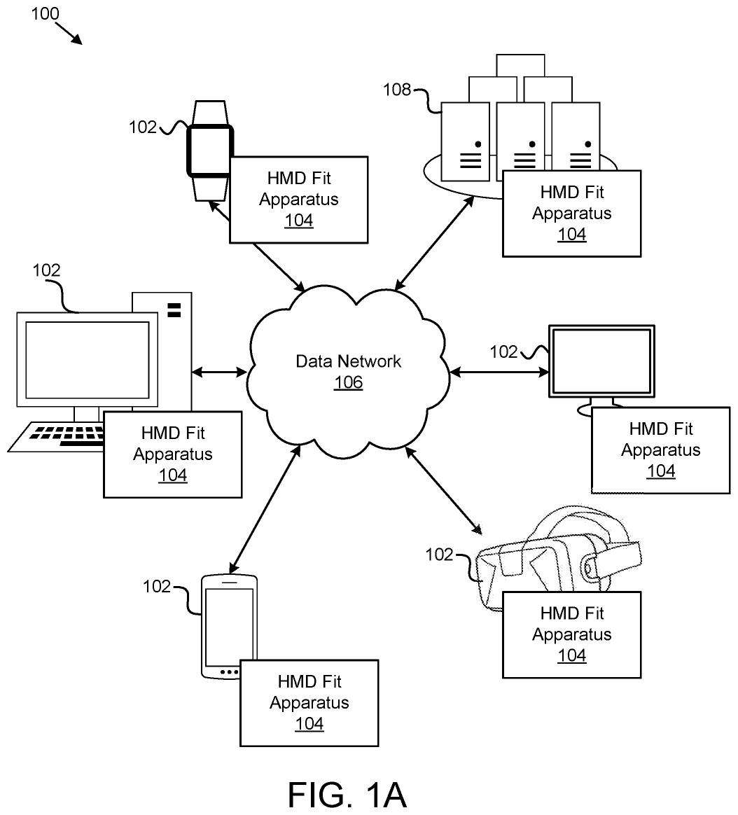

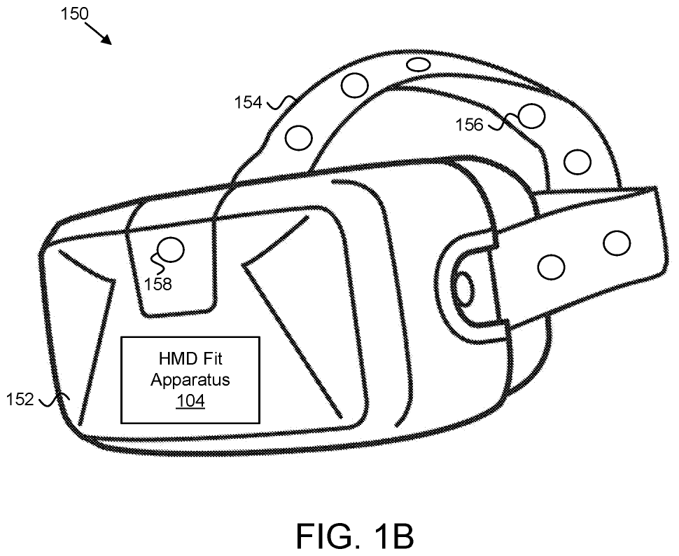

FIG. 1 is a schematic block diagram illustrating one embodiment of a system 100 for fit adjustment of a head mounted display. In one embodiment, the system 100 includes one or more information handling devices 102, one or more HMD fit apparatuses 104, one or more data networks 106, and one or more servers 108. In certain embodiments, even though a specific number of information handling devices 102, HMD fit apparatuses 104, data networks 106, and servers 108 are depicted in FIG. 1, one of skill in the art will recognize, in light of this disclosure, that any number of information handling devices 102, HMD fit apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

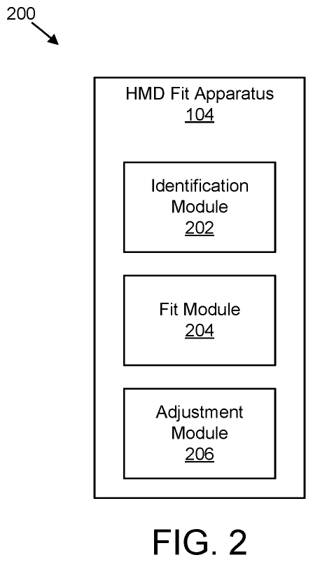

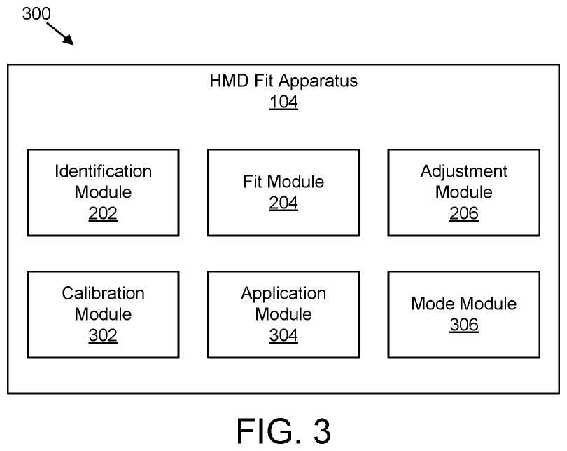

In general, in one embodiment, the HMD fit apparatus 104 is configured to identify a user based on information captured using one or more sensors of a head mounted display (“HMD”) unit. As used herein, a head mounted display may refer to a display device, worn on the head or as part of a helmet, that has a small display optic in front of one or each eye. An HMD unit may be used in various applications such as virtual reality/augmented reality, gaming, aviation, engineering, medicine, and/or the like. In certain embodiments, an HMD fit apparatus 104 is further configured to determine one or more fit settings for the identified user, the one or more fit settings for sizing the HMD unit to the identified user and automatically adjust the HMD unit based on the determined one or more fit settings for the identified user. The HMD fit apparatus 104, including its various sub-modules, may be located on one or more information handling devices 102 in the system 100, one or more servers 108, one or more network devices, and/or the like. The HMD fit apparatus 104 is described in more detail below with reference to FIGS. 2 and 3.

In various embodiments, the HMD fit apparatus 104 may be embodied as part of an information handling device 102 such as a headset, a head mounted display, a smart device, a network device, an Internet of Things device, a computing device, or as a hardware appliance that can be installed or deployed on an information handling device 102, on a server 108, on a user's mobile device, on a display, or elsewhere on the data network 106.

In certain embodiments, the HMD fit apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the HMD fit apparatus 104 may include a power interface, a wired and/or wireless network interface, a graphical interface that attaches to a display, and/or a semiconductor integrated circuit device as described below, configured to perform the functions described herein with regard to the HMD fit apparatus 104.

The HMD fit apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the HMD fit apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the HMD fit apparatus 104.

The semiconductor integrated circuit device or other hardware appliance of the HMD fit apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the HMD fit apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may host, store, stream, or the like files and content to a different device such as documents, videos, music, podcasts, images, games, web pages, augmented and/or virtual reality environments, and/or the like, and may host, store, and make accessible public databases such as blockchain databases, as described in more detail below.

FIG. 1B illustrates one example embodiment of an HMD unit 150. The HMD unit 150, as used herein, may refer to a device that is worn on the head or as part of a helmet. An HMD unit 150 may include a display unit 152 that is on the user's face over the user's eyes. The display unit 152 may comprise a single display, two displays corresponding to the user's eyes, or multiple different displays. The display unit 152 may further include a computing device, e.g., logic hardware and software, for performing various functions. In such an embodiment, the display unit 152 includes an instance of an HMD fit apparatus 104.

In further embodiments, the HMD unit 150 may include at least one securing member 154, e.g., straps, bands, belts, arms, or the like, for securing the HMD unit 150 to the user's head. The securing members 154 may be adjustable, flexible, or the like to fit to different user's head sizes and characteristics. The HMD unit 150 may include various sensors 156 on the securing members 154, on the display unit 152, and/or the like. The sensors 156 may include proximity sensors, motion sensors, pressure sensors, biometric sensors, and/or the like. The HMD unit 150 may include at least one camera 158 on the display unit 152 and/or on other parts of the HMD unit 150, e.g., on the securing members 154.

FIG. 2 is a schematic block diagram illustrating one embodiment of an apparatus 200 for fit adjustment of a head mounted display. In one embodiment, the apparatus 200 includes an instance of an HMD fit apparatus 104. In one embodiment, the HMD fit apparatus 104 includes one or more of an identification module 202, a fit module 204, and an adjustment module 206, which are described in more detail below.

In one embodiment, the identification module 202 is configured to identify a user based on information captured using one or more sensors 154 of a head mounted display (“HMD”) unit 150. In such an embodiment, the user may be a previous user of the HMD unit 150 and may have previously registered with the HMD unit 150, e.g., the user may have recorded or stored identifying information during a previous wear of the HMD unit 150.

Identifying information may include physical characteristics of the user such as various head characteristics (e.g., size, shape, hair style, or the like) that are captured/recorded using the sensors 154 on the HMD unit 150; may include biometric information such as a fingerprint; may include electronic credentials such as a username/password, passphrase, PIN, or the like (which may be entered on the display unit 152; may include wireless signature information such as a smart phone identifier, a smart watch identifier, or the like (e.g., a MAC address, an IP address, a unique device identifier, a serial number, a Bluetooth® identifier, and/or the like), which can be detected, received, and processed at the HMD unit 150.

In further embodiments, the identification module 202 identifies the user based on at least one of image data captured using at least one camera 158 of the HMD unit 150. The identification module 202 may capture one or more images of the user's face or other identifying physical features, e.g., the user's eyes and cross-reference that with an image database, e.g., of registered users, using facial recognition to determine the identity of the user.

In one embodiment, the fit module 204 is configured to determine one or more fit settings for the identified user. The fit settings, as used herein, may refer to parameters, values, settings, or the like for sizing the HMD unit 150, or particularly, the securing members 154 to the user's head. The fit settings, for example may include the size of the user's head, the shape of the user's head, the user's hairstyle, and/or the like. The fit settings may have been previously measured, recorded, captured, stored, and/or the like during an initial wear of the HMD unit 150, during an initial calibration process (see below), and/or the like and may be stored as data or metadata associated with the user.

In one embodiment, the adjustment module 206 is configured to automatically adjust the HMD unit 150 based on the determined one or more fit settings for the identified user. More specifically, the adjustment module 206 automatically adjusts the securing members 154 using the fit settings for the user in response to the user putting the HMD unit 150 on his/her head.

For instance, in one embodiment, the HMD unit 150 may include securing members 154 that include adjustable straps or bands. In such an embodiment, the adjustment module 206 communicates with, activates, triggers, or the like a motor, e.g., a servo-motor, a stepper motor, or the like, that is operably coupled to a strap or band and is configured to tighten or loosen the strap or band according to the fit settings, e.g., by actuating a mechanism for pulling or tightening and loosening the straps/bands by an amount that corresponds to the fit settings for the user.

In such an embodiment, the fit settings may include values representing a tension, an amount of strap/band to be released or pulled in, a pressure, and/or the like. In some embodiments, where the HMD unit 150 includes multiple different straps/bands, each strap/band may include an independent motor, and the fit settings may include settings for each motor or strap/band, e.g., the fit settings may be defined on a per-motor or per-strap/band basis.

In certain embodiments, the adjustment module 206 automatically adjusts the HMD unit 150 by adjusting one or more characteristics of at least a portion of the HMD unit 150 that is in contact with the user's head. For instance, the adjustment module 206 may adjust various characteristics of portions of the display unit 152, the securing members 154, portions that go against the user's ears, and/or the like. In such an embodiment, the adjustable characteristics of the portions of the HMD unit 150 that contact the user's head may comprise adjustable material such as shape memory alloy, variable density foam, and/or the like.

In such an embodiment, the adjustment module 206 may adjust a firmness of the shape memory alloy and/or the variable density foam based on information sensed using sensors such as strain gauges integrated into the HMD unit 150. In such an embodiment, the adjustment module 206 may adjust a characteristic, e.g., a temperature or pressure, of the shape memory alloy and/or the variable density foam to change the size, shape, or other characteristics of the shape memory alloy and/or the variable density foam to conform or otherwise fit the user's head.

In further embodiments, the adjustment module 206 further adjusts the HMD unit 150 based on input received from the user. The input may include a voice command, a menu selection on the display unit 154, a gesture such as a hand gesture, and/or the like. The user input may specify a specific securing member that needs to be tightened or loosened, a portion of the HMD unit 150 that needs to be tightened or loosened with more or less pressure, and/or the like. For example, the user may say “tighten the strap over my right ear,” which the adjustment module 206 would tighten, e.g., by activating the motor operably coupled to the strap over the user's right ear, until the user says “stop” or until a threshold pressure or tightness is detected.

In this manner, the user does not have to manually adjust the securing members of an HMD unit 150, which is especially useful in an environment where multiple different users where the HMD unit 150, e.g., such as at work, at school, or the like. Moreover, the HMD fit apparatus 104 provides a more comfortable and secure fit of the HMD unit 150 that is specifically tailored to the different characteristics of the user's head, e.g., if a user has a ponytail one day, but not the next.

FIG. 3 is a schematic block diagram illustrating one embodiment of another apparatus 300 for fit adjustment of a head mounted display. In one embodiment, the apparatus 300 includes an instance of an HMD fit apparatus 104. The HMD fit apparatus 104, in certain embodiments, includes an identification module 202, a fit module 204, and an adjustment module 206, which may be substantially similar to the identification module 202, the fit module 204, and the adjustment module 206 described above with reference to FIG. 2. The HMD fit apparatus 104, in further embodiments, includes one or more of a calibration module 302, an application module 304, and a mode module 306, which are described in more detail below.

The calibration module 302, in one embodiment, is configured to calibrate a fit of the HMD unit 150 for the user to initially determine the one or more fit settings for the user. In such an embodiment, the calibration module 302 may run a calibration program, process, application, or the like on the display unit 154.

The calibration module 302, in one embodiment, instructs the user, e.g., using commands or prompts provided on the display unit 154 or as voice sent through a speaker on the display unit 154, to point at least one camera 158 of the HMD unit 150 at the user's head. When the user's head is detected in the field of view of the camera 158, the calibration module 302 captures one or more images of the user's head using the camera 158. The calibration module 302 may instruct the user to move the camera around the user's head to get images of various angles, lighting, perspectives, and/or the like of the user's head.

In some embodiments, the calibration module 302 processes the captured images using image processing algorithms, either on the HMD unit 150 or on a device that is remote, but communicatively coupled, to the HMD unit 150 to determine one or more fit settings for the user based on the captured images. For instance, the calibration module 302 may detect the user's head size, head shape, and/or other characteristics of the user's head, e.g., a hairstyle, based on the processed images.

In various embodiments, the calibration module 302 may use machine learning/artificial intelligence, and/or other algorithms to determine, calculate, or the like a confidence with which the one or more fit settings are determined, are accurate, or the like for the user. For instance, the calibration module 302 may input the fit values captured from the images of the user's head, and/or other input from the user and/or other external sources, to a machine learning engine, which has been trained on head data, to predict, forecast, estimate, and/or the like the fit settings for the user and/or one or more confidence values associated with the fit settings.

In such an embodiment, the calibration module 302 determines whether the confidence values satisfy predetermined confidence thresholds, and if so, provides an indication to the user, e.g., a visual indication, an audible indication, and/or the like to the user that the HMD unit 150 is calibrated for the user responsive to the confidence satisfying the predetermined confidence threshold, e.g., 90%.

In some embodiments, the calibration module 302 loosens the securing members 154 and instructs the user to set the HMD unit 150 on his head. The calibration module 302 may then, in a stepwise fashion, tighten the securing members 154 and/or change the pressure/form of the shape memory allow/variable density foam, until an accurate and comfortable fit for the user's head is detected. The calibration module 302 may then store the fit settings associated with the achieved fit of the HMD unit 150. A comfortable fit may be achieved in response to a detected tightness or pressure of the securing members 154 satisfying a predefined comfort level and/or in response to user input, e.g., a voice response saying that the fit is “good.”

In various embodiments, the calibration module 302 determines, detects, and/or the like that a fit of the HMD unit 150 is improper, off, inaccurate, and/or the like for the user. For instance, the calibration module 302 may detect that one or more securing members 154 are too loose or too tight, that the display unit 154 is sitting crooked on the user's face, and/or the like, e.g., if a user didn't have a ponytail during initial calibration, but now does, which changes the fit of the HMD unit 150.

In such an embodiment, the calibration module 302 triggers, activates, initiates, commands, starts, and/or the like recalibration of the fit of the HMD unit 150 for the user, as described above, and updates the one or more fit settings for the user based on the recalibration. In certain embodiments, the calibration module 302 triggers recalibration for only the particular securing member 154 that needs to be adjusted assuming the fit settings for the other securing members are still accurate.

In one embodiment, the application module 304 is configured to further adjust the HMD unit 150 based on one or more fit settings for an application executing on the HMD unit 150. For instance, some applications may require a tighter fit on the user's head, e.g., if the application requires the user to move around with quick or violent movements, whereas the HMD unit 150 may be secured comfortably on the user's head for other applications that do not require much movement or intense, quick movements, e.g., an application for providing training or instructions.

The application module 304 may determine the types of movements that an application requires based on metadata for the application, previous executions of the application, online information about the application, and/or the like. The application module 304 may determine whether the movements satisfy a threshold for tightening the securing members 154 in response to the application being executed and/or may change the tightness of the securing members 154 during execution of the application, e.g., if certain features or portions of the application require quicker movements, and consequently tighter securing members, versus other features or portions of the application. In other words, the application module 304 may cause the adjustment module 206 to change the tightness or fit of the securing members 154 during execution of the application based on the activities/motions that the application requires at a certain point in time.

In one embodiment, the mode module 306 is configured to create different sets of fit settings for the user based on different fit modes that the user defines. For instance, the user may manually adjust, or cause to be adjusted, the securing members 154 and may store the fit settings for the adjustment as one set of fit settings. Furthermore, the HMD unit 154 may have predefined sets of fit settings such as tight, comfortable, loose, and/or the like, which the user may further refine and store as a different set of fit settings. The user may then select, e.g., by voice or by a menu selection, a predefined set of fit settings for the securing members 154 of the HMD unit 150, which the adjustment module 206 adjusts in response to the selection.

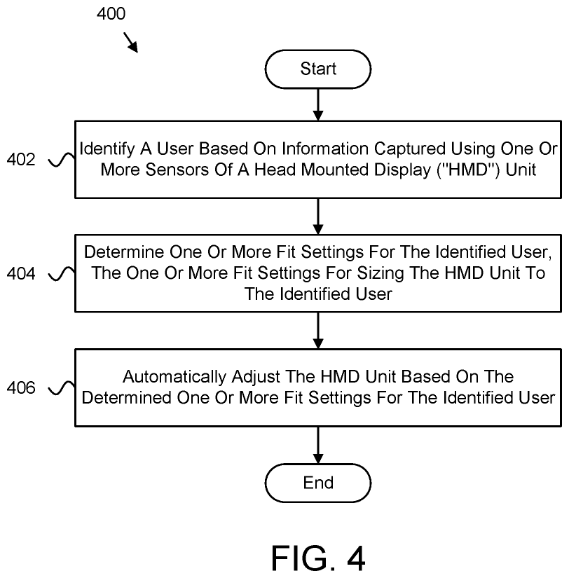

FIG. 4 is a schematic flow chart diagram illustrating one embodiment of a method 400 for fit adjustment of a head mounted display. In one embodiment, the method 400 begins and identifies 402, by a processor, a user based on information captured using one or more sensors 156 of a head mounted display (“HMD”) unit 150. In further embodiments, the method 400 determines 404 one or more fit settings for the identified user for sizing the HMD unit 150 to the identified user. In further embodiments, the method 400 automatically adjusts 406 the HMD unit 150 based on the determined one or more fit settings for the identified user, and the method 400 ends. In one embodiment, the identification module 202, the fit module 204, and the adjustment module 206 perform the various steps of the method 400.

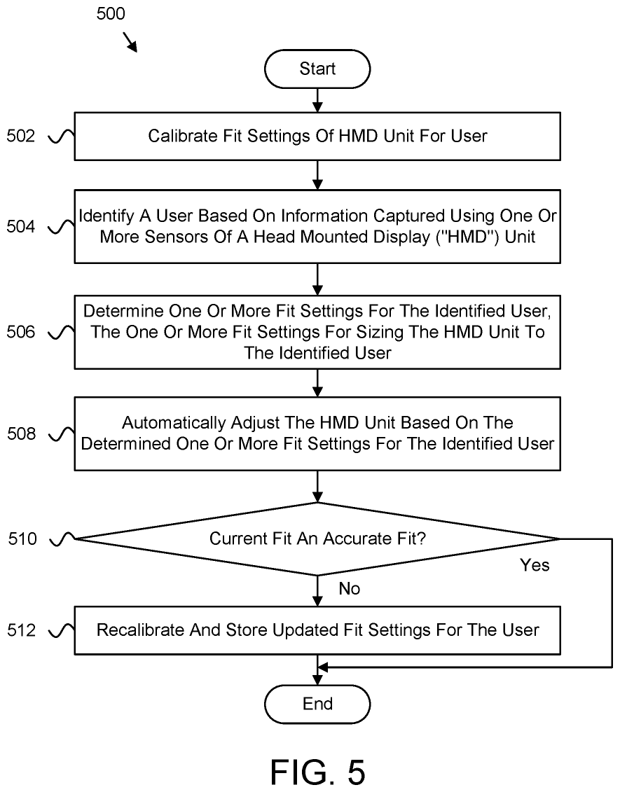

FIG. 5 is a schematic flow chart diagram illustrating one embodiment of another method 500 for fit adjustment of a head mounted display. In one embodiment, the method 500 begins and initially calibrates 502 the fit of an HMD unit 150 for a user's head. The method 500, in some embodiments, later identifies 502 the user based on information captured using one or more sensors 156 of the HMD unit 150. In further embodiments, the method 500 determines 504 one or more fit settings for the identified user, e.g., based on the initial calibration, for sizing the HMD unit 150 to the identified user and automatically adjusts 506 the HMD unit based on the determined one or more fit settings for the identified user.

In certain embodiments, the method 500 determines 508 whether the current fit of the HMD unit 150 is an accurate fit for the user based on the determined fit settings. If not, the method 500 recalibrates 510 the fit settings of the HMD unit 150 for the user and stores the updated fit settings, and the method 500 ends. In one embodiment, the identification module 202, the fit module 204, the adjustment module 206, and the calibration module 302 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
identify a user based on information captured using one or more sensors of a head mounted display (“HMD”) unit;
determine one or more fit settings for the identified user, the one or more fit settings for sizing the HMD unit to the identified user; and
automatically adjust the HMD unit based on the determined one or more fit settings for the identified user.

2. The apparatus of claim 1, wherein the code is executable by the processor to automatically adjust the HMD unit by adjusting at least one securing member that is configured to secure the HMD unit to the user's head.

3. The apparatus of claim 2, wherein the code is executable by the processor to actuate at least one motor of the HMD unit that is operably coupled to the at least one securing member to adjust the at least one securing member.

4. The apparatus of claim 1, wherein the code is executable by the processor to automatically adjust the HMD unit by adjusting one or more characteristics of at least a portion of the HMD unit that is in contact with the user's head and is used to secure the HMD unit to the user's head, the at least a portion of the HMD unit comprising a shape memory alloy and/or a variable density foam that has an adjustable firmness.

5. The apparatus of claim 4, wherein the firmness of the shape memory alloy and/or the variable density foam is adjustable based on information sensed using one or more strain gauges integrated into the HMD unit.

6. The apparatus of claim 1, wherein the code is executable by the processor to calibrate a fit of the HMD unit for the user to initially determine the one or more fit settings for the user.

7. The apparatus of claim 6, wherein the code is executable by the processor to:
instruct the user to point at least one camera of the HMD unit at the user's head;
capture one or more images of the user's head using the camera; and
determine one or more fit settings for the user based on the captured images.

8. The apparatus of claim 7, wherein the code is executable by the processor to:
calculate a confidence with which the one or more fit settings are determined for the user;
determine whether the confidence satisfies a predetermined threshold; and
provide an indication to the user that the HMD unit is calibrated for the user responsive to the confidence satisfying the predetermined threshold.

9. The apparatus of claim 6, wherein the code is executable by the processor to:
determine that a fit of the HMD unit is improper for the user;
trigger recalibration of the fit of the HMD unit for the user; and
update the one or more fit settings for the user based on the recalibration.

10. The apparatus of claim 1, wherein the code is executable by the processor to identify the user based on at least one of image data captured using at least one camera of the HMD unit, biometric data captured using at least one biometric sensor of the HMD unit, and wireless signature data for a wireless device associated with the user using one or more wireless signal sensors of the HMD unit.

11. The apparatus of claim 1, wherein the code is executable by the processor to further adjust the HMD unit based on one or more fit settings for an application executing on the HMD unit.

12. The apparatus of claim 1, wherein the code is executable by the processor to further adjust the HMD unit based on input received from the user, the input comprising at least one of a voice command, a menu selection, and a gesture.

13. The apparatus of claim 1, wherein the code is executable by the processor to create different sets of fit settings for the user based on different fit modes that the user defines, the HMD unit adjusted according to the fit settings for a selected fit mode.

14. A method, comprising:
identifying, by a processor, a user based on information captured using one or more sensors of a head mounted display (“HMD”) unit;
determining one or more fit settings for the identified user, the one or more fit settings for sizing the HMD unit to the identified user; and
automatically adjusting the HMD unit based on the determined one or more fit settings for the identified user.

15. The method of claim 14, further comprising automatically adjusting the HMD unit by adjusting at least one securing member that is configured to secure the HMD unit to the user's head.

16. The method of claim 15, further comprising actuating at least one motor of the HMD unit that is operably coupled to the at least one securing member to adjust the at least one securing member.

17. The method of claim 14, further comprising calibrating a fit of the HMD unit for the user to initially determine the one or more fit settings for the user by:
instructing the user to point at least one camera of the HMD unit at the user's head;
capturing one or more images of the user's head using the camera; and
determining one or more fit settings for the user based on the captured images.

18. The method of claim 17, further comprising:
calculating a confidence with which the one or more fit settings are determined for the user;
determining whether the confidence satisfies a predetermined threshold; and
providing an indication to the user that the HMD unit is calibrated for the user responsive to the confidence satisfying the predetermined threshold.

19. The method of claim 14, further comprising:
determining that a fit of the HMD unit is improper for the user;
triggering recalibration of the fit of the HMD unit for the user; and
updating the one or more fit settings for the user based on the recalibration.

20. A computer program product, comprising a computer readable storage medium having program instructions embodied therewith, the program instructions executable by a processor to cause the processor to:
identify a user based on information captured using one or more sensors of a head mounted display (“HMD”) unit;
determine one or more fit settings for the identified user, the one or more fit settings for sizing the HMD unit to the identified user; and
automatically adjust the HMD unit based on the determined one or more fit settings for the identified user.
